(19) United States
(12) Patent Application Publication
(10) Pub. No.: US 2016/0289110 A1
(43) Pub. Date: Oct. 6, 2016

(54) CASSETTE TYPE MODULAR WATER TREATMENT PACKAGE SYSTEM

(71) Applicant: KOREA INSTITUTE OF CONSTRUCTION TECHNOLOGY, Goyang-si (KR)

(72) Inventors: Hyun Je OH, Goyang-si, Gyeonggi-do (KR); Ju Suk AN, Anyang-si, Gyeonggi-do (KR); Yun Jeong CHOI, Goyang-si, Gyeonggi-do (KR); Young Kyu PARK, Goyang-si, Gyeonggi-do (KR)

(21) Appl. No.: 14/442,384

(22) PCT Filed: Nov. 10, 2014
(86) PCT No.: PCT/KR2014/010720

§ 371 Date: May 12, 2015

(30) Foreign Application Priority Data
Nov. 11, 2013 (KR) 10-2013-0136071

(51) Int. Cl. C02F 9/00; C02F 1/32; C02F 1/00; C02F 1/28; C02F 1/52; C02F 1/44; C02F 1/76

(52) U.S. Cl. CPC C02F 9/005; C02F 1/444; C02F 1/442; C02F 1/441; C02F 1/32; C02F 1/76; C02F 1/28; C02F 1/52; C02F 1/008; C02F 2201/007; C02F 2201/008; C02F 2209/005

(57) ABSTRACT

Disclosed is a cassette type modular water treatment package system for water treatment, including a container in which water treatment modules are installed.

### TECHNICAL FIELD

The present invention relates to a cassette type modular water treatment package system in which a plurality of water treatment modules is provided in one container.

### BACKGROUND ART

Recently, there is a fast growing need for water treatment equipment to supply cleaned water (treated water). Korean Patent Publication No. 10-2009-0102618 discloses an example of a water treatment system according to a related art. FIG. 1 is a schematic diagram illustrating a water treatment system according to a related prior art. The water treatment system 10 according to the related prior art includes a water reservoir 1 for supplying raw water (untreated water), a storage tank 2 for storing water supplied from the water reservoir 1, a mix basin 3 in which chemicals are fed and mixed with the raw water, a coagulation basin 4 for forming flocks with rotating paddles, a sedimentation basin 5 for settling the flocks included in the water from the coagulation basin 4 and removing the settled matter, a filtration basin 6 for filtering off impurities included in the water, and a water treatment basin 7 for sterilizing the filtered water and for supplying it to each destination.

However, the water treatment system 10 according to the related prior art has a plurality of devices for water treatment installed in a distributed manner, making it difficult to manage. Also, to install the water treatment system 10 according to the related prior art in areas of unsatisfactory operation of an existing water supply system or poor construction of a water supply system, a lot of installation costs and a separate installation space are needed. Thus, the water treatment system 10 according to the related art has a disadvantage of limited utility.

### DISCLOSURE

### Technical Problem

The present invention aims to present technology for small-scale cassette type modular water treatment package system in which a plurality of water treatment devices used in the water treatment system is installed in one container and can be moved as needed, to treat water of various qualities and readily provide the cassette type modular water treatment package system to needy areas.

### Technical Solution

To achieve the object, the present invention provides a cassette type modular water treatment package system, in which raw water supplied from a water reservoir is discharged through a treated water tank after a water treatment process, including a plurality of water treatment modules provided with water treatment devices for removing contaminants included in the raw water, and a container in which the plurality of water treatment modules is provided inside connectably to each other and which may be divided into a plurality of zones to receive the plurality of water treatment modules in arrangement, the plurality of zones being separated by a plurality of guide units protruding in an inward direction of the container from one surface of the container.

### Advantageous Effects

Because the present invention has a structure in which the plurality of water treatment modules used in treating water is installed in one container, the present invention has an advantage that the water treatment modules may be combined to suite characteristics of regions with insufficient water supplies. Also, according to the present invention, because a space required to arrange the water treatment modules is small and the water treatment modules are moveable, there is an advantage that the water treatment modules are readily available and may supply treated water in rural areas in an urgent need for water supply. Furthermore, because the water treatment modules may be selected and used based on properties of raw water being supplied to the raw water tank, there is an advantage that an optimal raw water quality may be supplied to a user.

### DESCRIPTION OF DRAWINGS

FIG. 1 is a schematic diagram illustrating a water treatment system according to a related art.

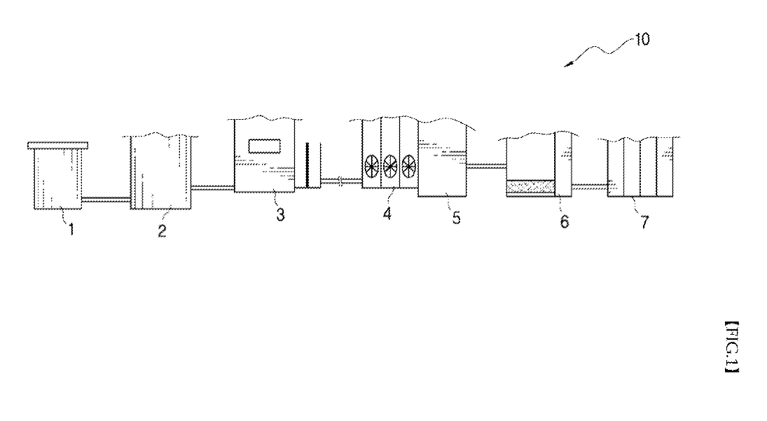

FIG. 2 is a perspective view illustrating a container for receiving a plurality of water treatment modules according to an exemplary embodiment of the present invention.

FIG. 3 is a diagram illustrating an exemplary arrangement layout of a plurality of water treatment modules in an internal space of a container.

FIG. 4 is a perspective view illustrating a detailed construction of a container according to the present invention.

FIG. 5 is a perspective view illustrating a detailed construction of a water treatment module according to the present invention.

FIG. 6 is a rear elevation diagram from the rear of water treatment modules, illustrating a plurality of water treatment modules is connected with connection pipes in the present invention.

FIG. 7 is an operation explanatory diagram of a water treatment module illustrating insertion of the water treatment module into an internal space of a container according to an exemplary embodiment of the present invention.

### BEST MODE

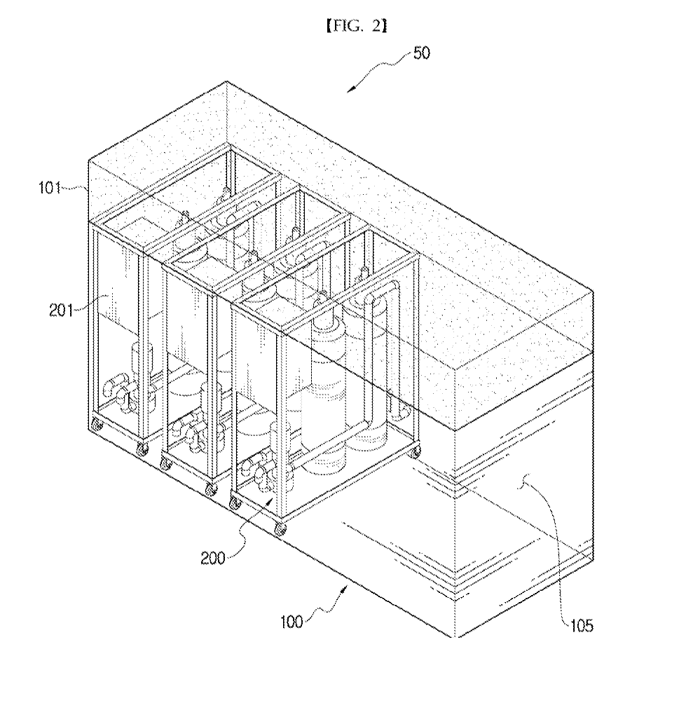

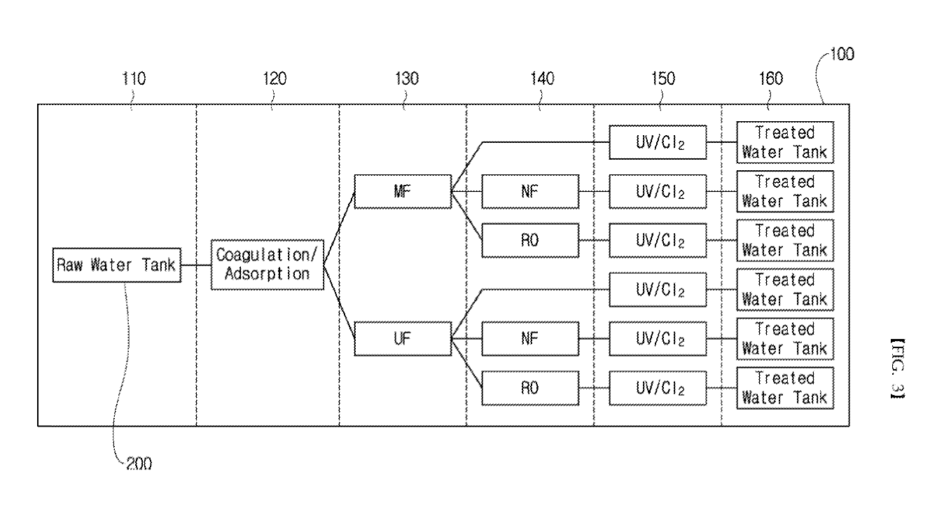

FIG. 2 is a perspective view illustrating a container for receiving a plurality of water treatment modules according to an exemplary embodiment of the present invention, and FIG. 3 is a diagram illustrating an exemplary arrangement layout of a plurality of water treatment modules in an internal space of the container.

A cassette type modular water treatment package system 50 of the present invention includes a plurality of water treatment modules 200 provided with water treatment devices configured to remove contaminants included in raw water. The cassette type modular water treatment package system 50 of the present invention includes a container 100 in which the plurality of water treatment modules 200 is disposed inside and connected to each other. In each of the plurality of water treatment modules 200, a manual control device 201 may be provided to manually select an operation mode of the respective water treatment modules 200 or control the operation of the water treatment modules 200. In the container 100, an automatic control device 101 is installed to automatically select an operation mode of the respective water treatment modules 200 or control the operation of the water treatment modules 200. The manual control device 201 and the automatic control device 101 are provided with a monitoring unit for a user to monitor an operation condition of the respective control devices and an operation condition of the water treatment modules using a video, an audio, and other various methods.

The container 100 has a module receiving unit 105 in which the plurality of water treatment modules 200 may be installed. In the container 100, the plurality of water treatment modules 200 may be arranged in parallel, and for example, when six water treatment modules 200 are arranged in the container 100, the container 100 may be divided into a first zone 110, a second zone 120, a third zone 130, a fourth zone 140, a fifth zone 150, and a sixth zone 160. The container 100 may be provided with various types of supplementary installations necessary for a water treatment process, for example, pumps and sensors.

A process of sequential movement of raw water from the first zone 110 to the sixth zone 160 may correspond to a water treatment process of supplied raw water. For example, a raw water tank may be placed in the first zone 110. The raw water from the raw water tank is treated through a pre-treatment process which performs coagulation or adsorption, a main treatment process which filters water to selectively remove a particulate matter or a dissolved matter, a post-treatment process which separates contaminants, and a sterilization process which sterilizes a separated solvent, i.e., water, and the treated water may be supplied to a user through a treated water tank.

In the main treatment process, a microfiltration (MF) device with a membrane used for microfiltration or an ultrafiltration (UF) device with a membrane allowing penetration based on a molecular size may be used. In the post-treatment process, a reverse osmosis (RO) device or a nanofiltration (NF) device, which filters off contaminants using osmosis water applies to a membrane, may be used. Also, in the sterilization process, an ultraviolet (UV) device using UV rays or a chlorine feed device may be used.

In the present invention, for example, a raw water tank may be placed in the first zone 110, a coagulation device or an adsorption device may be placed in the second zone 120, a main treatment device may be placed in the third zone 130, a post-treatment device may be placed in the fourth zone 140, a sterilization device may be disposed in the fifth zone 150, and a treated water tank may be placed in the sixth zone 160.

However, an arrangement layout of the water treatment modules 200 in the container 100 is not limited to the above example. If raw water does not need to pass through the post-treatment device, the sterilization device may be placed in the fourth zone 140 instead of the post-treatment device. In the present invention, space partitioning of the container 100 is intended to divide a space into zones by functions of the water treatment modules 200 to increase the user convenience. Thus, there is no limitation on the arrangement layout of the water treatment modules 200 so long as damage does not occur in the functions of the water treatment modules 200. For example, a sensing unit (not shown) may be installed in the first zone 110 to determine the turbidity (cloudiness) of raw water flowing into the raw water tank and whether organics, inorganics and heavy metals are contained in the raw water. A subsequent water treatment process may change based on information sensed by the sensing unit. For example, when the turbidity of raw water is low and a concentration of contaminants such as organics, inorganics and heavy metals is less than a standard value, the water treatment process may be performed using only the main treatment device and the sterilization device. In this case, the main treatment device may be installed in the second zone 120, the sterilization device may be installed in the third zone 130, and the fourth, fifth, and sixth zones 140, 150, and 160 may leave empty.

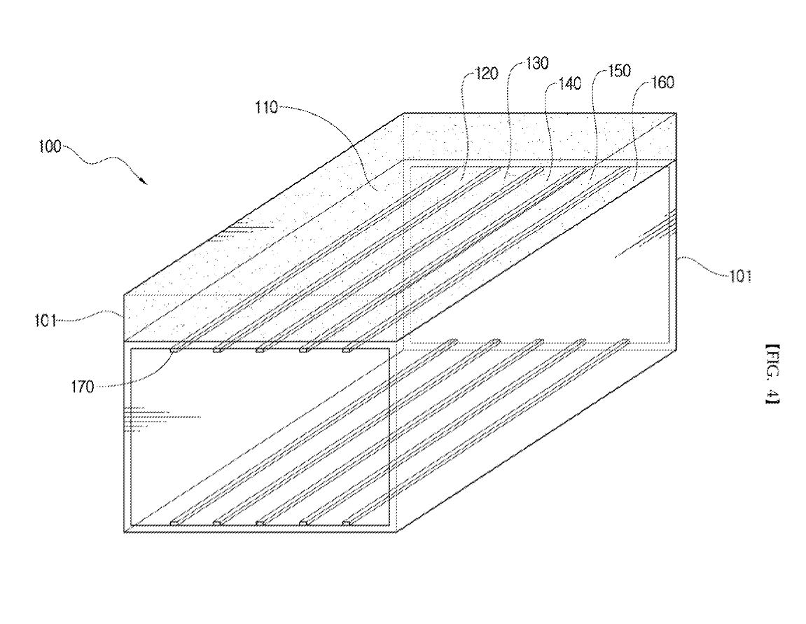

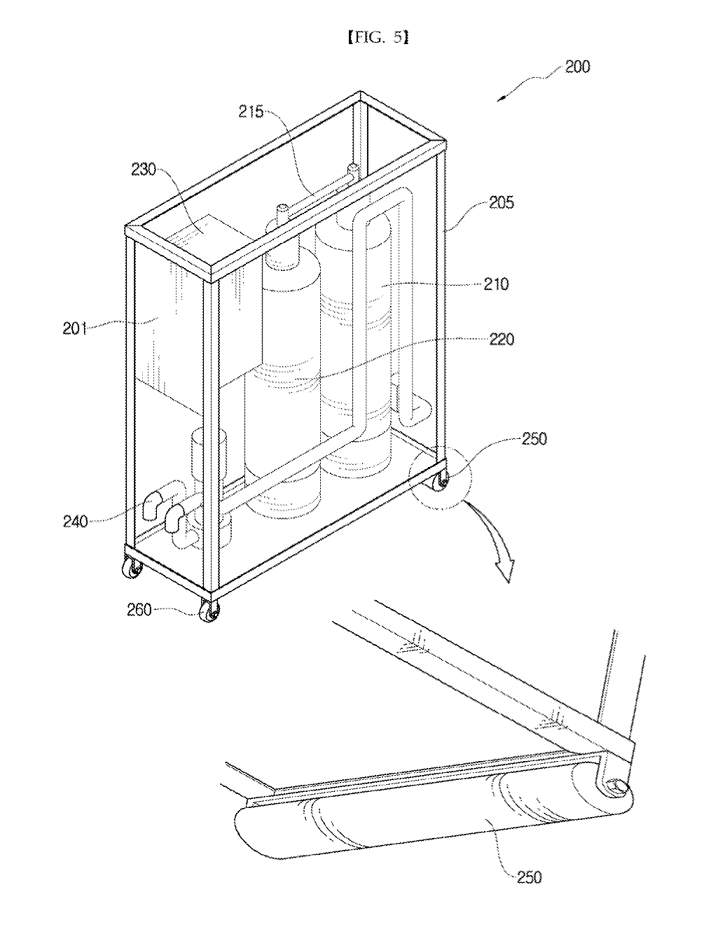

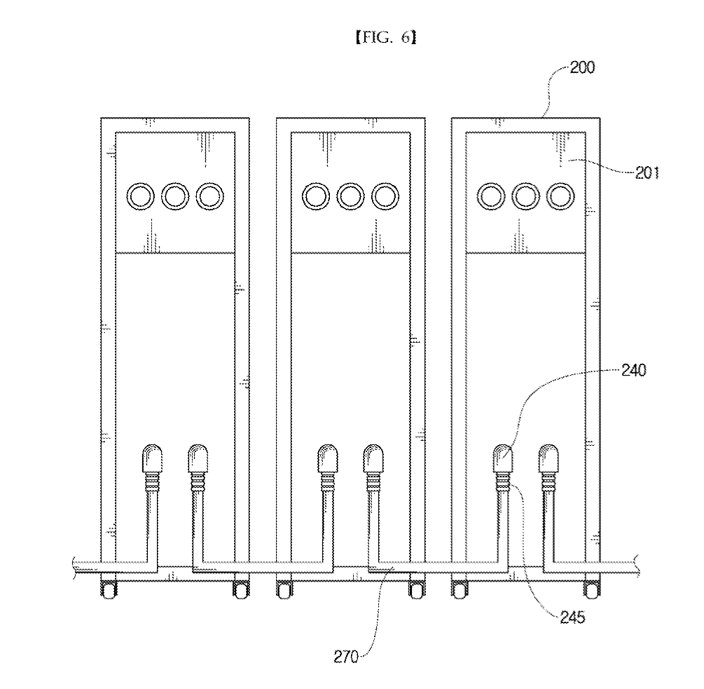

FIG. 4 is a perspective view illustrating a detailed construction of the container according to the present invention, FIG. 5 is a perspective view illustrating a detailed construction of the water treatment module according to the present invention, and FIG. 6 is a rear elevation diagram from the water treatment modules, illustrating a plurality of water treatment modules is connected with connection pipes.

Referring to FIG. 4, the container 100 of the present invention has the plurality of zones in which the plurality of water treatment modules 200 is installed. The plurality of zones formed in the container 100 may be separated by guide units 170 protruding from one surface of the container 100. For example, as shown in FIG. 4, the guide units 170 may protrude in an inward direction of the container 100 from each of an upper surface and a lower surface of the container 100.

The guide units 170 may include first guide units installed along a length on the upper surface of the container 100, and second guide units installed along a length on the lower surface of the container 100. However, locations and a number of the guide units 170 are not limited thereto. The guide units 170 may be a protrusion formed at an inlet part of the container 100 where the water treatment modules 200 are inserted into the container 100.

When the container 100 is divided into the first to sixth zones 110, 120, 130, 140, 150, and 160, five pairs of the guide units 170 may be arranged. Also, six water treatment modules 200 with differing functions may be respectively disposed in the first to sixth zones 110, 120, 130, 140, 150, and 160.

Each of the plurality of water treatment modules 200 may be controlled by the automatic control device 101 equipped in the container 100. Although in the drawings, the automatic control device 101 is illustrated as being disposed at an upper part of the container 100, an installation location of the automatic control device 101 is not limited thereto.

In FIG. 5, as the water treatment module 200 placed in the fourth zone 140 inside, an example of the water treatment module 200 with a post-treatment device is illustrated. The water treatment module 200 includes a module housing 205 defining an outer shape, and a plurality of water treatment devices arranged in the module housing 205. A microfiltration device 210 which filters off micro-contaminants, an ultrafiltration device 220 which is connected to the microfiltration device 210 by an adjuster tube 215 and allows water to pass therethrough but filters off a polymer material or a colloidal material, and a sensing unit 230 which senses the condition of water flowing into the module housing 205 may correspond to the plurality of water treatment devices. An operator may control the operation and an operation mode for each of the plurality of water treatment modules 200 by controlling the manual control device 201 installed in the module housing 205.

On an outer surface of the module housing 205, a protruding tube 240 may be installed to guide the flow of water into the water treatment module 200 or guide the discharge of water having passed through the water treatment module 200. A movement member may be installed at the bottom of the module housing 205 to guide the movement of the water treatment module 200. The movement member may include a wheel 260 placed on one side of the module housing 205 at the bottom of the module housing 205, and a roller 250 placed on the other side of the module housing 205 at the bottom of the module housing 205. A pair of wheels 260 may be provided. The roller 250 may be formed of a member having a cylindrical shape. The roller 250 may have such a shape that the roller 250 extends in a direction perpendicular to a direction in which the water treatment module 200 is inserted into the container 100. Thus, when the water treatment module 200 is inserted into the container 100, the water treatment module 200 may be inserted smoothly without swaying in the left and right directions by virtue of the roller 250. Even if swaying occurs during moving of the water treatment module 200, the movement of the water treatment module 200 may be guided by re-adjusting a rotation location using the wheels 260.

A connection relationship between the plurality of water treatment modules 200 is illustrated in FIG. 6.

The adjacent water treatment modules 200 may be connected by a guide pipe 270, and the guide pipe 270 allows water to move from one water treatment module to another water treatment module adjacent thereto. The protruding tube 240 is connected to the guide pipe 270. Thus, the plurality of water treatment modules 200 is connected to each other by the guide pipe 270. The guide pipe 270 may be formed of, for example, a synthetic resin pipe. Between the protruding tube 240 and the connection pipe 270, a connector 245 may be installed to prevent water leakages and provide a secure connection.

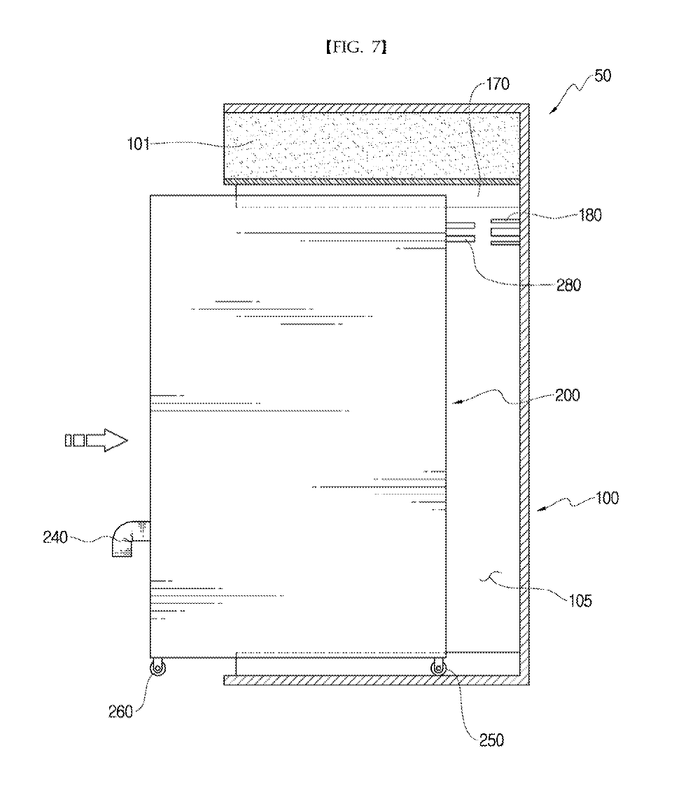

FIG. 7 is a diagram illustrating a process of inserting the water treatment modules into the internal space of the container according to an exemplary embodiment of the present invention. In the container 100 according to an exemplary embodiment of the present invention, a signal transmission unit 180 may be installed to supply power to the plurality of water treatment modules 200 and transmit information associated with the operation of the water treatment modules 200 to the water treatment modules 200 when the plurality of water treatment modules 200 is inserted into the container 100. The signal transmission unit 180 may be installed protrusively in an inward direction from an inner surface of the container 100. The automatic control device 101 installed in the container 100 receives the information transmitted through the signal transmission unit 180, and selects an operation mode of the respective water treatment modules 200 or controls the operation of the water treatment modules 200. In the water treatment modules 200, a power receiving unit 280 for receiving the power supplied from the signal transmission unit 180 may be installed.

Upon insertion of the plurality of water treatment modules 200 into the container 100, a connection of the signal transmission unit 180 and the power receiving unit 280 is established and the plurality of water treatment modules 200 starts to operate. Thus, by the power supplied through the signal transmission unit 180, the plurality of water treatment devices arranged in the water treatment modules 200 operates to perform a water treatment process. However, a method of supplying power to the water treatment devices is not limited thereto. For example, power may be delivered by directly connecting power supply equipment to the water treatment devices.

According to the present invention, because the plurality of water treatment modules used in the cassette type modular water treatment package system is arranged in one container, there is an advantage that the water treatment modules are used in combination suited to regional characteristics. Particularly, because each of the water treatment modules may be detached from the container as needed, the present invention has an advantage that individual maintenance and management and independent operation is enabled for each water treatment module.

What is claimed is:

1. A cassette type modular water treatment package system in which raw water supplied from a water reservoir is discharged through a treated water tank after undergoing a water treatment process, the cassette type modular water treatment package system comprising:
a plurality of water treatment modules (200), each comprising a module housing (205) defining an outer shape, and a water treatment device placed in the module housing (205) to remove contaminants included in the raw water; and
a container (100) having a module receiving unit (105) formed inside, in which the plurality of water treatment modules (200) is installed connectably to each other in the module receiving unit (105), and a plurality of first guide units protruding from an upper lower surface of the container and a plurality of second guide units protruding from a lower surface of the container are installed in the module receiving unit (105) to place the plurality of water treatment modules (200) in a parallel arrangement within the module receiving unit (105), the module receiving unit (105) being divided into a plurality of zones by the first guide units and the second guide units,
wherein a roller (250) and a pair of wheels (260) are installed at a lower surface of the module housing (205) of the water treatment module, the roller (250) extending along a length in a direction perpendicular to a movement direction of the water treatment module to guide the movement of the water treatment module to zones divided within the container (100), the wheels being configured to guide a movement direction of the roller (250),
a manual control device (201) is provided for each of the plurality of water treatment modules to select an operation mode of the respective water treatment modules or control operation of the water treatment modules,
a guide pipe (270) is connected between adjacent water treatment modules among the plurality of water treatment modules to allow water to move from one water treatment module to another water treatment module placed adjacent thereto, and
a signal transmission unit (180), a power receiving unit (280), and an automatic control device (101) with a monitoring unit are installed in the container (100), the signal transmission unit (180) being configured to, when the plurality of water treatment modules is respectively inserted into the module receiving unit (105), supply power to the plurality of water treatment modules and transmit information associated with operation of the water treatment modules, the power receiving unit (280) being configured to receive the power supplied through the signal transmission unit (180), the automatic control device (101) being configured to receive the information transmitted from the signal transmission unit (180) and select an operation mode of the respective water treatment modules and control the operation of the water treatment modules, the monitoring unit being configured to allow a user to monitor an operation condition of the respective control devices and an operation condition of the respective water treatment modules.
